(19) United States
(12) Patent Application Publication
(10) Pub. No.: US 2016/0202139 A1
(43) Pub. Date: Jul. 14, 2016

(54) CONTAMINATION DETECTION FOR PIPELINES

(71) Applicant: APPARATEBAU GAUTING GMBH, Gauting (DE)

(72) Inventor: Jan-Boris PHILIPP, Muenchen (DE)

(73) Assignee: APPARATEBAU GAUTING GMBH, Gauting (DE)

(21) Appl. No.: 14/993,230

(22) Filed: Jan. 12, 2016

(30) Foreign Application Priority Data
Jan. 12, 2015 (DE) 102015000080.2

(51) Int. Cl. G01M 3/28

(52) U.S. Cl. CPC G01M 3/2815

(57) ABSTRACT

In a method for determining the contamination rate of a pipeline, a pressure value of an internal pressure at a measuring location of the pipeline is determined during a flushing procedure using a flushing medium in the pipelined, and the contamination rate is determined by evaluating the pressure value by means of a test criterion. For the contamination rate of a pipeline system, a contaminated location is additionally determined by evaluating the contamination rates by means of a locating criterion.

Corresponding devices contain an interface for the pressure value, and an evaluation unit for determining the contamination rate or of the contaminated location according to the methods mentioned above.

A computer program serves for carrying out the above-mentioned methods.

A pressure sensor which is operatively connected with an internal pressure of a pipeline is used in one of the above-mentioned methods.

### BACKGROUND OF THE INVENTION

The invention relates to a method and to devices for determining a contamination rate of a pipeline and of a pipeline system, and to the use of a pressure sensor, and to a computer program.

### DISCUSSION OF THE PRIOR ART

Pipelines, in particular those which serve for conducting wastewater, that is to say wastewater pipelines, may be contaminated. Such contamination is created in particular by deposits on the inner wall of the pipe or by foreign matter in the interior of the pipe. The pipeline here in particular may be part of a pipeline system. The pipeline may also be a negative-pressure pipeline, for example a pipeline of a negative-pressure wastewater system. In such a case wastewater is suctioned with the aid of negative pressure from an inlet, for example a toilet, through the pipeline. Such negative-pressure wastewater systems are to be found in particular in vehicles, in particular in aircraft.

The contamination leads to a constriction of the internal cross section of the pipe, in the worst case to clogging of the latter. It is problematic that any nascent contamination in a pipeline is not evident when the latter is used. However, if the contamination is noted, for example by wastewater which no longer is drained or is drained in a hesitant manner, immediate cleaning of the pipe is typically required in order for the latter to be able to be used in a normal manner. Until then, utilization of said pipeline is limited if not impossible. This is disruptive above all in the case of the above-mentioned wastewater pipes in a vehicle, in particular in an aircraft, when contamination arises in flight, for example. Maintenance work in order for the wastewater pipe to be serviceable again is most often only possible on the ground after the next landing.

It is thus usual, in particular in the case of aircraft, for a corresponding pipeline to be at least partially disassembled and to be visually inspected already in a preventive manner, for example at regular time intervals. This often means a pointless effort when it is finally established that the pipeline is not contaminated. For example, it has hitherto been necessary in the case of an aircraft for a toilet, a pipe length of the wastewater line, or a piece of the wastewater tank to be disassembled in order to obtain access to the pipe system or to be able to perform visual or manual inspection, respectively.

The disassembly effort required may be at least partially reduced by employing endoscopes. However, there is always a basic effort which remains.

### SUMMARY OF THE INVENTION

One aspect of the invention is to improve contamination management in pipelines. More particularly, the method of the present invention serves for determining a contamination rate of a pipeline. In particular, the pipeline is a wastewater pipe. The wastewater pipe is one of a negative-pressure wastewater system, in particular. According to the method, a pressure value of an internal pressure of the pipeline is determined at at least one measuring location of the pipeline. Determination is carried out in the pipeline at least during a flushing procedure, that is to say while a flushing medium or a medium, respectively, is flushed through the pipeline. The contamination rate is determined in that the pressure value is evaluated by means of a test criterion.

The invention will be discussed in the following in part by means of a wastewater pipe or of a wastewater system, respectively, but in an analogous manner is transferable to all other comparable pipelines or systems, respectively.

The pipeline is a wastewater pipe in a vehicle, in particular. In particular, the vehicle is an aircraft. The wastewater pipe serves in particular for conveying away wastewater from an inlet for wastewater, in particular from a toilet, a washbasin, or from any other disposal installation, for example from a GWDU (galley waste disposal unit), in particular of an aircraft.

In particular, the wastewater pipe opens into a downstream wastewater tank. In the case of a negative-pressure wastewater system, the wastewater tank in relation to the inlet for wastewater into the pipeline is under negative pressure. The negative pressure serves for suctioning the wastewater from the inlet through the wastewater pipe into the tank.

A flushing medium is flushed through the pipeline during the flushing procedure. In particular, the flushing procedure is performed using a flushing medium which in any case contains gas, optionally and additionally also a fluid. To this end, air with or without water may be readily chosen as the flushing medium, for example. In particular, aircraft wastewater systems which operate on the negative-pressure principle, in any case use conventional air as a suction medium, water being optionally added to the air typically at the inlet of the pipeline. The respective method in this way may be carried out in a particularly simple manner in an aircraft wastewater system, using media which is available in any case, for example.

The determined contamination rate is, for example, a simple binary value which provides information as to whether or not there is any contamination in the pipeline, or whether or not cleaning of the pipeline is necessary. Alternatively, however, this may also be a numeric value which provides information pertaining to the level of contamination or when cleaning is likely to have to be performed, so as to avoid clogging of the pipeline. On account of contamination, the free cross section of the pipeline that remains available for perfusion is reduced, in particular, influencing the contamination rate and the pressure ratios during a flushing procedure. The length of the pipe portion across which a contamination extends in particular influences the resistance to flow (proportional to 1/length) and thus the pressure ratios. Furthermore, the formation of turbulences in the pipeline is influenced in particular by the shape of the contamination. The pressure prevailing in the case of contamination thus depends on the cross section, the shape, and the length of the contamination.

The invention is based on the concept that determining the contamination rate in wastewater pipes to date has always been a manual procedure or required manual procedures. Automatic systems are unknown to date.

The invention is furthermore based on the concept that it is desirable to have available an automatic system or method which provides the contamination rate in good time, prior to any clogging caused by contamination, for example by deposits, arising in a pipeline system. In this way, a warning that the pipeline is to be cleaned may be issued, for example. This then enables targeted and anticipatory cleaning of the pipeline, which however needs to take place only when there is an actual requirement. By way of a corresponding method, maintenance on demand is thus possible.

The invention is furthermore based on the concept that the pressure ratios in the line vary during a flushing procedure, depending on the contamination rate in a pipeline. The absence of any contamination means increased perfusion through the pipeline and thus higher pressure. Any contamination reduces perfusion and thus flow.

One advantage of the invention lies in that the method dispenses with visual inspection of the pipeline, and in that only measured pressure values have to be recorded and the latter have to be correspondingly evaluated. The respective method is therefore capable of automation, there is no longer any requirement for a manual procedure, leading to significantly reduced operating costs.

In this way the contamination rate may be repeatedly determined—even at short temporal intervals—in a rapid and simple manner, and corresponding manual measures have to be resorted to only when a critical contamination rate has been reached. In this way, cleaning and/or disassembly of the pipeline may be carried out only when needed, for example. Cleaning may also be scheduled in good time, or it may be ensured that cleaning at this time is not required.

The most varied of possibilities are conceivable for evaluating the determined internal pressure or for the test criterion, respectively. To this end and in the most general form, a contamination model is used, and the determined pressure value is evaluated by means of this contamination model. The contamination model here defines how the pressure is varied at specific contamination rates G.

Analytical or empirical methods may be employed in the evaluation. It is only necessary for a theoretical or a measured or an observed correlation between contamination and effects on the pressure ratios to be inverted, for example, in order to be able to in turn draw conclusions pertaining to contamination based on the pressure ratios.

With a view to determining at least one pressure value, a plurality of pressure values in particular and the latter in particular during the flushing procedure or else additionally also prior and/or post thereto may be determined or measured or recorded, respectively.

In one preferred embodiment a test flush is performed as the flushing procedure. In the context of the test flush, the pipeline is flushed out with a test medium. The flushing parameters which influence the correlation between the contamination rate and the pressure ratios in the line here are known. Flushing parameters include, for example, the pressures at the entry and exit of the pipe, the quantity of the medium being flushed in the test flush, the inflow velocity of the medium, the medium per se, etc. According to this variant of the invention, test conditions which are defined in particular by establishing the flushing parameters are achieved, so as to render the pressure measurements in the interior of the pipeline comparable with one another and/or with reference or comparison values. In this way, a comparison of measured pressures in various flushing procedures is possible in particular also in a qualitative manner, for example. By creating known or uniform test conditions, respectively, by known flushing parameters or by establishing said conditions, respectively, conclusions pertaining to the contamination rate may be particularly readily drawn from the pressure measurement. In other words, therefore, fixed or known test conditions, respectively, are created in or on the pipeline, respectively.

In one preferred embodiment, a comparison by means of the testing criterion is performed as the evaluation. In the comparison, the determined pressure value is compared with at least one known reference value in particular for a known contamination rate. The reference value here is a known value which has been determined in an empirical manner or by experiments, for example. For example, it is known under suitable test conditions which contamination rate requires pipe cleaning, and which pressure is to be expected at a contamination rate of this type. The measured pressure is then compared with the respective reference pressure, so as to decide whether or not pipe cleaning is necessary.

In one preferred embodiment, a profile of pressure values of the internal pressure over time is determined. This is performed at least during part of the duration of the flushing procedure. The temporal profile of the pressure values results in a measured curve of the pressure profile over time. The contamination rate is determined by evaluating the measured curve by means of the test criterion. This variant is based on the concept that in particular the temporal profile of the pressure ratios in the pipe interior varies depending on the contamination rate. The resulting measured curves are thus particularly suitable for creating effective and simple test criteria by means of which conclusions pertaining to the contamination rate may be drawn from the measured curve.

In a variant of this embodiment, a parameter is determined from the measured curve as an evaluation by means of the test criterion. Furthermore, a comparison of the parameter with a known reference parameter, in particular for a known degree of contamination, is carried out. Simple and meaningful characteristics can be derived from the profile of pressure values over time, that is to say the measured curve, generally better than from individual measured values. In this way, a multiplicity of parameters are available for being able to define corresponding measured curves and differentiate the latter depending on respective contamination rates. In this way, particularly effective and qualitative test criteria of high quality may be achieved, and a correspondingly positive evaluation in terms of the contamination rate may be performed. The known reference parameters again are determined by means of experiments or in an empirical manner.

In one variant of this embodiment a variable of a maximum and/or minimum internal pressure, that is to say of the measured curve, and/or a gradient of a temporal increase and/or decrease in the internal pressure, that is to say of the measured curve, is determined as the parameter. The maximum or minimum pressure level which is established during a flushing procedure, and the rapidity of the increase or decrease in pressure are particularly significant parameters which in the case of various contamination rates in a pipeline vary in a particularly intense manner and thus particularly well allow conclusions pertaining to various contamination rates to be drawn from measured values. The conclusions may be particularly readily drawn by way of a comparison or by smaller-than/greater-than decisions.

In one preferred embodiment a reduction of the cross section of the pipeline in relation to the nominal cross section of the pipeline is determined as the contamination rate. The nominal cross section is the cross section of the pipeline in the uncontaminated state. The cross section is the proportion of area which is transverse to the pipeline and which is available for perfusion. On account of the ratios in terms of fluid dynamics in a pipeline, a variation in the cross section through which a medium may pass through the pipeline has a particularly intense effect on the pressure ratios in the pipeline. Respective contamination rates may thus be particularly readily determined or recognized, respectively, by evaluating pressure. Alternatively, the length, that is to say the extent of the contamination along the pipeline, and/or the shape of the contamination, should also be considered in the contamination rate in the case of more complex models.

In one preferred embodiment, a pipeline which is downstream, that is to say in the conveying direction of the medium, opens into a collection container is used as the pipeline. The internal pressure in the collection container is then used as the internal pressure of the pipeline. This pressure directly correlates to the internal pressure of the pipeline at that end of the line that opens into the tank, or is equal to that pressure, respectively. The internal pressure of the pipeline at that end of the line that opens into the tank is thus known. The internal pressure in the collection tank is typically easy to determine, since the collection container anyway already has pressure sensors which may be conjointly used for the respective determination of pressure, for example.

In one preferred embodiment, the pressure values of the internal pressure are determined at at least two measuring locations along the pipeline. The measuring locations delimit respective part-portions of the pipeline which are strung together along the longitudinally extending direction thereof. A respective contamination rate is then determined for at least one, in particular all of the part-portions. The part-portions are thus strung along the line and delimited by a respective pressure sensor and/or an end of the line. Since the contamination rates are thus determinable for part-portions of the pipeline, statements may be reached pertaining to the localized distribution of contaminations along the pipeline. It may be established, for example, whether a contamination is located upstream or downstream of a specific one of the pressure sensors.

According to the invention, a method capable of automation for detecting pipeline constrictions which are caused by deposits and/or foreign objects, in particular in an aircraft wastewater system results. The method is based on measuring pressures or of pressure profile curves, respectively, after a flushing procedure using air with or without water has been initiated.

One aspect of the invention is directed to a method for determining a contamination rate of a pipeline system. The pipeline system has at least two intercommunicating pipelines. The pipeline system furthermore has at least two inlets through which during operation a medium, for example wastewater, which is to be conveyed through the pipeline system makes its way into the pipeline system. According to the method, respective flushing procedures are successively performed in the pipelines. The flushing procedures thus take place so as to be temporally offset and not simultaneous. In particular, one flushing procedure is terminated prior to the next flushing procedure commencing. In the case of each flushing procedure, a flushing medium is introduced into the pipeline system at in each case only one of the inlets and flushed through the pipeline system. The flushing procedures are performed for at least two, preferably for all of the wastewater inlets. A contamination rate of the respectively flushed pipeline is determined according to the above-mentioned method for each flushing procedure. The pipeline here is that pipeline along which the flushing medium flows from the inlet up to the exit from the pipeline system. A contaminated location is then determined by evaluating the determined contamination rates by means of a locating criterion.

The widest variety of possibilities is also conceivable for evaluating the determined contamination rates or for the locating criterion, respectively. Here too, analytical or empirical methods may be employed. It is only necessary for a theoretical or a measured or an observed correlation between contaminated locations and the (total) contamination rates resulting and determined therefrom to be inverted, in order to be able to again draw conclusions pertaining to the contaminated locations from the contamination rates, for example.

The method is based on the concept that depending on the geometry of the pipeline system it is known in the case of the respective flushing operations which are performed through various inlets, which parts of the pipeline system are flushed out in a specific flushing path. Should there be any contamination present in the current flushing path, said contamination is identified in the context of being associated with this flushing path. Various flushing paths in portions here typically run through the same pipeline in common, and partially through different pipelines. It is thus typically possible for conclusions pertaining to the individual contaminations in the common or different pipelines, and thus localized distribution of the contaminations, that is to say the contaminated locations, to be drawn from the contamination rates for the flushing paths. In other words, a contamination image of the entire pipeline system may be typically reconstructed. In this way, statements as to where respective contaminations are to be found, that is to say in which pipelines or pipeline portions the respective contaminations are to be found, may be made.

Another aspect of the invention is directed to a device for determining a contamination rate of a pipeline, in particular of a wastewater pipe, in particular of a negative-pressure wastewater system. The device contains an interface for inputting at least one pressure value of an internal pressure at at least one measuring location of the pipeline during a flushing procedure using a flushing medium in the pipeline. The device also contains an evaluation unit which is configured for determining the contamination rate by evaluating the pressure value by means of a test criterion.

The present invention is further directed to a device for determining a contamination rate of a pipeline system which contains at least two intercommunicating pipelines and at least two inlets. The device contains the device which has just been discussed. However, the evaluation unit is additionally configured for determining a contaminated location by evaluating at least two contamination rates by means of a locating criterion, wherein the contamination rates are determined for temporally offset flushing procedures through in each case one of at least two, preferably all of the inlets in the pipelines.

The devices have already been discussed in an analogous manner in conjunction with preferred embodiments and the advantages thereof in the context of the methods according to the invention.

The present invention is still further directed to the use of a pressure sensor which is operatively connected with an internal pressure in a pipeline. The pressure sensor here is used for determining the pressure values of the internal pressure in the pipeline in a method according to the invention. In this way, each pressure sensor which in any way is operatively connected with an internal pressure of a pipeline is suitable for determining the internal pressure and thus for determining the contamination rate according to the method according to the invention, and may be used to this end. The pressure sensor here may already be present in a given system and therein fulfil another purpose. On account of the mentioned use, the sensor then has a second use and henceforth has a dual function. In this way, the installation of an additional pressure sensor in a corresponding system is avoided.

In one preferred embodiment, the pressure sensor of a filling-level transducer is used for the methods according to the invention. This here is the filling-level transducer of a collection tank. The pipeline which is to be examined according to the methods here opens into this collection tank. The collection tank is in particular a negative-pressure wastewater tank of a vehicle. The vehicle is in particular an aircraft. The pressure sensor in the form of the filling-level transducer, which in any case is present in the collection tank, thus is imparted a dual function, or a further option of use, respectively, in order to accomplish the detection of pressure in the above-mentioned methods. Since the above-mentioned methods in particular in the case of aircraft are performed when the aircraft is on the ground, the filling-level function at this point of time may be dispensed with and the sensor may be used without restrictions for the methods according to the invention. Moreover, the installation of a further pressure sensor in the aircraft is avoided.

### BRIEF DESCRIPTION OF THE DRAWINGS

Further features, effects, and advantages of the invention are derived from the following description of a preferred exemplary embodiment of the invention and from the appended figures in which:

FIG. 1 shows a pipeline system of an aircraft;

FIG. 2 shows a flow diagram for a method for determining a contamination rate; and

FIG. 3 shows measured curves of pressures over time.

### DETAILED DESCRIPTION OF THE DRAWINGS

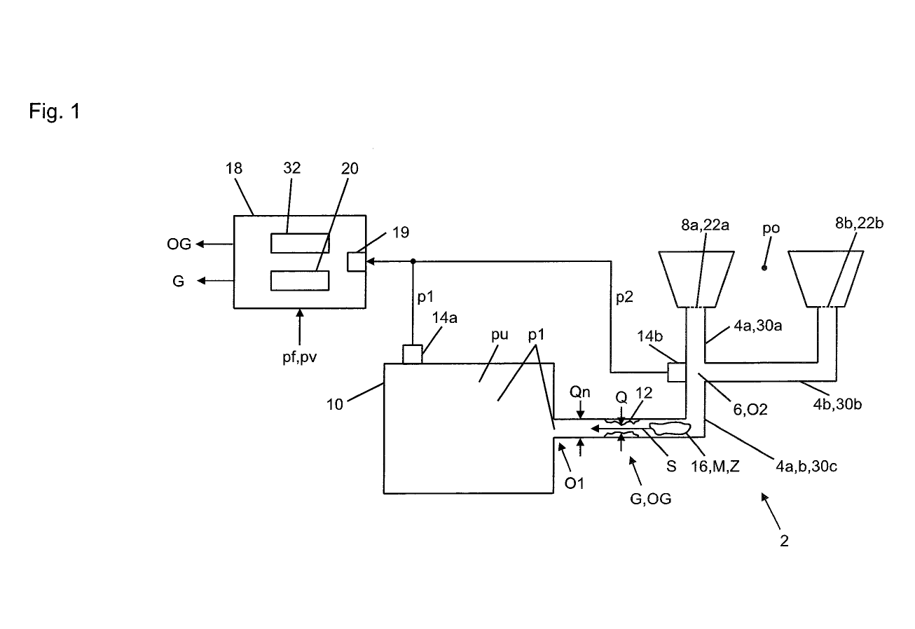

FIG. 1 shows an exemplary pipeline system 2 in the form of a wastewater system of an aircraft (not illustrated). The pipeline system 2 has two pipelines 4a,b in the form of wastewater lines, which at a bifurcation 6 are interconnected in a Y shape. The pipelines 4a,b have a common portion 30c and in the shape of various stub lines in the form of portions 30a,b lead to a respective inlet 8a,b which is here a respective wastewater inlet in the form of an aircraft toilet. The pipelines 4a,b or the portion 30c, respectively, at the ends thereof which are opposite the inlets 8a,b open into a collection container 10 in the form of a negative-pressure tank.

An elevated pressure po prevails at the inlets 8a,b or in the surroundings thereof outside the pipeline system 2, respectively. In the example, this is the internal cabin pressure in the aircraft. Said internal cabin pressure is always known by way of the onboard control system, for example available on demand on the dedicated CAN bus of the aircraft. A negative pressure pu<po prevails in the collection container 10. The inlets 8a,b under normal conditions are closed by pressure-tight valves 22a,b. If and when one of the valves 22a,b is opened, which is typically for a short period, rinsing or flushing of the respective toilet takes place, on account of the pressure differential between po and pu, wastewater is flushed from said toilet through the pipeline 4a or 4b into the collection tank 10.

The pipelines 4a,b in the portion 30c have a contamination 12 in the form of a deposit on the internal wall of the pipe. On account of the contamination 12, the cross section Q of the pipeline 4a,b is reduced in relation to the nominal cross section Qn in the uncontaminated state. The intensity of the contamination 12 is defined by a contamination rate G. In the simplest example, the latter is equal to the ratio G=Q/Qn.

In order for the contamination rate G of the pipeline 4a to be determined, the following procedure is adhered to. The internal pressure p in the pipeline 4a is determined at the measuring location O1, namely at the point where the pipeline 4a opens into the collection container 10. This determination results in a pressure value p1. In the example, the internal pressure p is measured indirectly at the measuring location O in that a pressure sensor 14a which determines the pressure in the collection container 10 is used. This is possible since the same pressure as at the measuring location O1 prevails in the entire collection container 10. The pressure sensor is thus imparted dual utilization, since the pressure sensor 14a is otherwise used for determining the filling level in the negative-pressure wastewater tank. The pressure sensor 14a is thus misappropriated for recording said pressure value p1, or is used therefor in a dual function, respectively.

The pressure value p1 is determined in the pipeline 4a during a flushing procedure S, presently a special test flush. The flushing procedure S in FIG. 1 is indicated by an arrow and consists of a medium, in the example a test medium 16, namely air and water, which is especially used for determining contamination, being flushed through the pipeline 4a. To this end, the test medium is inducted into the respective toilet at the inlet 8a and into the pipeline 4a by opening the valve 22a. With the aid of the above-described negative pressure, said test medium is flushed through the pipeline 4a to the collection container 10. The flushing parameters of the test flush here are known. The latter include the quantity M of the test medium 16 and the composition Z of thereof, that is to say the proportions of air and water, as well as the pressure values pu and po which prevail prior to commencement of the test flush.

The pressure value p1 is evaluated by means of a test criterion 20 in an evaluation unit 18, and the contamination rate G is determined on account thereof. The pressure value p1 is infed to the evaluation unit 18 via an interface 19. In the context of the evaluation by means of the test criterion 20 the pressure value p1 which has been determined is compared with known reference values for known contamination rates. The known reference values have been determined by means of experiments as the reference value pf for a clear, that is to say uncontaminated pipeline 4a, and as the reference value pv for a pipeline 4a having a targeted contamination 12 at a contamination rate of 50%. It may be established by way of the mentioned comparison whether the current contamination rate G has not yet reached, has reached, or has exceeded the known contamination rate of 50%.

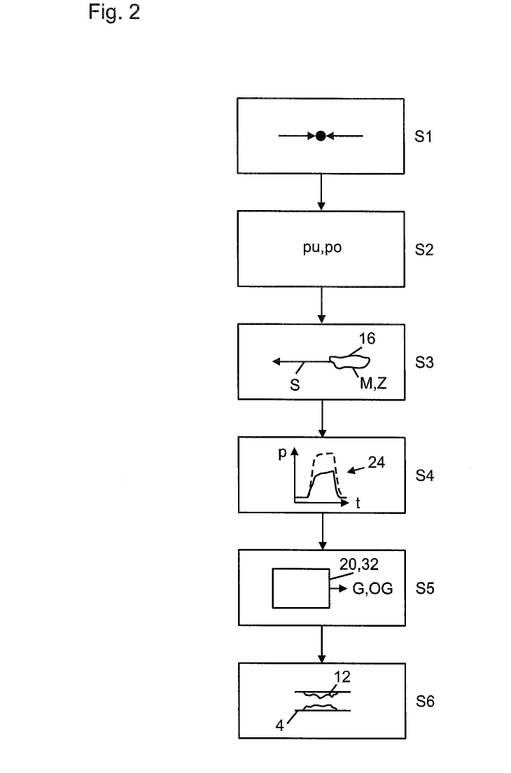

FIG. 2 shows a flow diagram for the mentioned method in detail. The method is carried out while the aircraft is on the ground during a flight break. In a first optional step S1 the pipeline system 2 is initially set to a defined state. This is performed by carrying out a “standard waste service” on the aircraft. Here, the collection container 10 is emptied or, alternatively, subsequently restored to a known filling level in that a known quantity of disinfectant is inducted into the collection container 10.

In a second optional step S2, defined pressure ratios are set for the pipeline system. In particular, a defined pressure pu in relation to the pressure po in the surroundings of the inlets 8a,b is set in the collection container 10. This is performed in that a vacuum generator (not illustrated) of the collection container 10 is set to a fixed pump output, the latter being known to generate the defined pressure pu. Alternatively, active pressure regulation is performed in the collection container 10, so as to regulate the internal pressure of the tank to the pressure pu. In this way, a defined relative pressure po-pu of the tank of the collection container 10 in relation to the ambient pressure po is created.

In a step S3, the flushing procedure S is performed in the pipeline 4a. Said flushing procedure S in particular is the above-mentioned test flush. Here, the defined quantity M of the test medium 16, in the example water and air in the composition Z, is flushed through the pipeline 4a. Flushing may optionally also be performed without water, that is to say only with air as the test medium 16.

In a step S4, at least one pressure value of the internal pressure of the pipeline 4a is determined, in particular by way of the above-mentioned pressure measurement.

In a step S5, the contamination rate G is determined by means of the test criterion 20.

In a method step S6, the determined state of the pipe, presently in particular the contamination rate G, is output, in the example in the form a report to service personnel (not illustrated). Depending on the contamination rate having been established to be above or below a critical threshold, in the example of 50%, a report stating “pipeline is in order” or “please clean pipeline” is output.

In one alternative embodiment a profile of the pressure values p1 at the measuring location O1 over time t is determined in step S4.

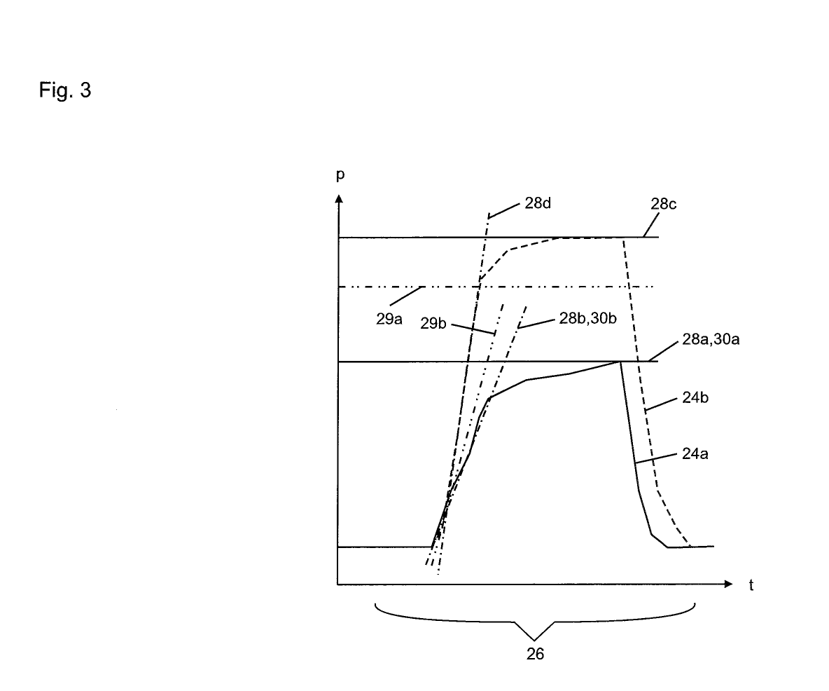

FIG. 3 shows in an exemplary manner two dissimilar measured curves 24a,b which may be created here. The measured curve 24b, which is drawn using dashed lines, has been recorded for an uncontaminated pipeline 4a, that is to say that there is no contamination 12. The cross section Q then corresponds to the nominal cross section Qn. The measured curve 24a in a solid line has been recorded in the state with a contamination 12, as is illustrated in FIG. 1. The pressure profile has in each case been plotted over the entire duration 26 of the flushing procedure S. The duration 26 is the time lapse which commences with the test medium 16 being inducted into the inlet 8a and which ends when the test medium 16 has departed from the pipeline 4a and has reached the collection container 10. A certain time lapse is created here between the test medium 16 entering and an initial increase of pressure arising.

In step S5, the measured curves 24a,b are evaluated by means of the contamination model, so as to determine the contamination rate G for the state of the pipe of the pipeline 4a. The contamination model here defines the variation of parameters which are determined in a general manner or of curve parameters of the measured curves, respectively, in the case of known contamination rates G or states of pipes, respectively. Exemplary parameters include the maximum pressure level of the pressure p up to which the measured curves 24a,b rise during the entire duration 26 of the flushing procedure S, or the mean gradient of the measured curves 24a,b at the commencement of the flushing procedure S. These parameters are plotted in as specific parameters 28a-d for the measured curves 24 in FIG. 3. The parameters are compared with reference parameters 29a,b (not illustrated) which have been determined empirically or experimentally, so as to determine the contamination rate G. The reference parameters 29a,b for one are plotted in an exemplary manner for a gradient and for a pressure level in the event of contamination.

A further variant of the method will be discussed by means of FIG. 1. Here, in addition to the measuring location O1, the internal pressure p of the pipeline 4a,b in the form of a pressure value p2 is determined at a second measuring location O2, namely at the bifurcation 6, using a second pressure sensor 14b. The internal pressure p is thus also determined at the entry of the portion 30c or at the ends of the portions 30a,b, respectively. The measuring location O2 subdivides the respective entire pipelines 4a,b from the inlets 8a,b to the collection container 10 into the respective portions 30a-c. Since the pressures at the entries and exits (when viewed in the flow direction of the wastewater) are in each case known for the corresponding portions 30a-c, the above-mentioned method may be carried out for every single portion 30a-c of the pipelines 4a,b, so as to separately determine the respective contamination rates G in the corresponding portions 30a-c. To this end, in total two flushing procedures S which are to be performed separately from one another are required, one through the inlet 8a and one through the inlet 8b.

On account thereof, the contamination rate G of the entire pipeline system 2 may be determined in a further variant of the method. To this end, the mentioned flushing procedures are performed in a temporally offset manner, and a contamination rate G is determined according to the above-mentioned method for each flushing procedure. Now, a respective contaminated location OG may be determined by evaluating the contamination rates G by means of a locating criterion 32. Namely, if the individual contamination rates G for the respective test flushes through the pipelines 4a and 4b, on the one hand, and the geometric arrangement of the pipelines 4a and 4c, on the other hand, are known, the contamination rates G by way of simple considerations pertaining to the respective superimposition of contamination rates or of pressure ratios, respectively, may be assigned to the individual pipelines 4a-c or to the portions 30a-c, respectively.

A determination of the contamination location OG may also be performed by only one pressure sensor 14a. The following example is intended to highlight this. A first flushing procedure S through the first inlet 8a leads to the statement that there is no contamination in the pipeline 4a, on account of which it is evident that the common line branch (portion 30c) as well as the stub line to the first inlet 8a (portion 30a) are uncontaminated. The second flushing procedure S through the second inlet 8b provides the statement that there is contamination at the contamination rate G in the pipeline 4b. The contamination, however, cannot be in the common line portion 30c, since the latter has already been identified as free of contamination. Therefore, the contamination has to be in the stub line (portion 30b) from the bifurcation 6 to the second inlet 8b. The contaminated location OG is thus the portion 30b, and the contamination rate is G.

### LIST OF REFERENCE SIGNS

2 Pipeline system

4a,b Pipeline

6 Bifurcation

8a,b Inlet

10 Collection container

12 Contamination

14a,b Pressure sensor

16 Test medium

18 Evaluation unit

19 Interface

20 Test criterion

22a,b Valve

24a,b Measured curve

26 Duration

28a-d Parameter

29a,b Reference parameter

30a-c Portion

32 Locating criterion

G contamination rate

M Quantity

Z Composition

O1, O2Measuring location

p Internal pressure

po Elevated pressure

pu Negative pressure

p1,2 Pressure value

pf, pv Reference value non-contaminated, contaminated

Q Cross section

Qn Nominal cross section

S Flushing procedure

S1-S6 Step

What is claimed is:

1. A method for determining a contamination rate of a pipeline comprising determining at least one pressure value of an internal pressure at at least one measuring location of the pipeline during a flushing procedure with a flushing medium in the pipeline and determining the contamination rate by evaluating the pressure value by means of a test criterion.

2. The method according to claim 1, wherein said pipeline is a wastewater pipe.

3. The method according to claim 2, wherein said wastewater pipe is part of a negative-pressure waste water system.

4. The method according to claim 1, wherein the pipeline in the context of a test flush is flushed by a test medium as the flushing procedure, using known flushing parameters.

5. The method according to claim 1, wherein a comparison of the pressure value with at least one known reference value for known contamination rates is performed as the evaluation by means of the test criterion.

6. The method according to claim 1, wherein a profile of the values of the internal pressure over time during at least part of the duration of the flushing procedure is determined as the measured curve, and the contamination rate is determined by evaluating the measured curve by means of the test criterion.

7. The method according to claim 6, wherein a parameter from the measured curve is determined as the evaluation by means of the test criterion, and a comparison of the parameter with known reference parameters for known degrees of contamination is carried out.

8. The method according to claim 7, wherein a variable of a maximum and/or minimum internal pressure and/or a gradient of a temporal increase or decrease in the internal pressure is determined as the parameter.

9. The method according to claim 1, wherein a reduction of the cross section of the pipeline in relation to the nominal cross section is determined as the contamination rate.

10. The method according to claim 1, wherein a pipeline which opens into a collection container is used as the pipeline, and the internal pressure in the collection container is determined as the internal pressure of the pipeline.

11. The method according to claim 1, wherein the pressure values of the internal pressure are determined at at least two measuring locations along the pipeline, wherein the measuring locations delimit respective part-portions of the pipeline and wherein a respective contamination rate for at least one is determined.

12. The method accordingly to claim 11, wherein the respective contamination rate for all part-portions are determined.

13. A method for determining a contamination rate of a pipeline system which contains at least two intercommunicating pipelines and at least two inlets, comprising:
performing respective flushing procedures in the pipelines in a temporally offset manner by in each case one of at least two of the inlets, and determining a contamination rate for each flushing procedure according to the method according to claim 1, and determining a contaminated location by evaluating the contamination rates by means of a locating criterion

14. A device for determining a contamination rate of a pipeline comprising:
an interface for inputting at least one pressure value of an internal pressure at at least one measuring location of the pipeline during a flushing procedure using a flushing medium in the pipeline, and an evaluation unit which is configured for determining the contamination rate by evaluating the pressure value by means of a test criterion.

15. A device for determining a contamination rate of a pipeline system which contains at least two intercommunicating pipelines and at least two inlets, comprising:
a device according to claim 14, in which the evaluation unit is additionally configured for determining a contaminated location by evaluating at least two contamination rates by means of a locating criterion, wherein the contamination rates for temporally offset flushing procedures in the pipelines are determined by in each case one of at least two of the inlets.

16. A computer program having programming code means so as to perform all steps of a method for determining a contamination rate of a pipeline comprising determining at least one pressure value of an internal pressure at at least one measuring location of the pipeline during a flushing procedure with a flushing medium in the pipeline and determining the contamination rate by evaluating the pressure value by means of a test criterion when the program is executed on a computer, on the device according to claim 14, or on a computer and the device according to claim 14.

17. A computer program having programming code means so as to perform all steps of a method for determining a contamination rate of a pipeline comprising determining at least one pressure value of an internal pressure at at least one measuring location of the pipeline during a flushing procedure with a flushing medium in the pipeline and determining the contamination rate by evaluating the pressure value by means of a test criterion when the program is executed on a computer, on the device according to claim 15, or on a computer and the device according to claim 15.

18. A pressure sensor for determining the pressure value in a pipeline by way of the method according to claim 1, wherein said pressure sensor is operatively connected with an internal pressure of the pipeline.

19. The pressure sensor according to claim 18, wherein said pipeline opens into a filling-level transducer of a collection tank.

20. The pressure sensor according to claim 19 wherein said collection tank is a negative-pressure wastewater tank of an aircraft vehicle.
